(19) United States
(12) Patent Application Publication
(10) Pub. No.: US 2023/0267492 A1
(43) Pub. Date: Aug. 24, 2023

(54) DISTRIBUTED LEDGER SYSTEM TO INCENTIVIZE DECENTRALISED APPLICATION (DAPP) OWNERS IN BLOCKCHAIN NETWORK

(71) Applicant: ANTIER SOLUTIONS PVT. LTD., Punjab (IN)

(72) Inventor: Vikram Raj Singh, Punjab (IN)

(21) Appl. No.: 17/849,648

(22) Filed: Jun. 26, 2022

(30) Foreign Application Priority Data
Feb. 24, 2022 (IN) 202211009859

(51) Int. Cl. G06Q 30/02

(52) U.S. Cl. CPC G06Q 30/0225

(57) ABSTRACT

Disclosed is a system and a method to facilitate incentivization to decentralized app (DApp) users and validators in a blockchain network. The method to facilitate incentivization includes determining an eligibility criterion for incentive distribution to a set of client nodes based on a count of minted nodes added to a network by the set of client nodes and obtaining a set of eligible client nodes from the set of client nodes based on the determined eligibility criterion. The method to facilitate incentivization further includes computing an incentive amount for each eligible client node of the set of client nodes respectively, computing an incentive amount for each validator node of a set of validator nodes respectively and transferring the computed incentive amounts specific to each eligible client node and every validator node, to each eligible client node and every validator node respectively.

### RELATED FIELD

The present disclosure relates to a field of blockchain. More particularly, the present disclosure relates to a feature of any public, private and/or hybrid blockchain to incentivize decentralised application (Dapp) owners with their native currency by defining their allocation within new coins minting algorithm may it be part of genesis block or any other area.

### BACKGROUND

Blockchain has become a mainstream service followed by more ready-to-deploy networks (layer-1 & layer-2) creating more challenges for businesses in making the apt choice. The essence of any blockchain is the algorithm written within the node client and the parameters mentioned in the genesis block or by any other mode through which the internal currency is minted and distributed among the validator nodes may it be based on Proof of Work (PoW). Proof of Stake (PoS), Delegated Proof of Stake (DPoS) or any other consensus algorithm. A decentralised application (DApp) developed by DApp developers is uploaded to a blockchain network that can operate autonomously, typically through the use of smart contracts, that runs on a decentralised, computing blockchain system. Moreover, DApp can provide some functions and/or utilities to the users. The DApp developers contribute to transaction volumes on the blockchain. However, the DApp owners are not rewarded and/or incentivized based on the transactions and/or usage of the smart contracts developed by the DApp owners. As the blockchain ecosystem is growing and new protocols are offering similar sets of technical features and ecosystem. There is a very thin line that separates one blockchain from another, this will be of utmost importance to attract DApp owners in choosing one blockchain over another and make them the part of the system.

### SUMMARY

In view of the foregoing, aspects of the present disclosure provide a distributed ledger system and a method to incentivize decentralized app (DApp) owners and validators in a blockchain network.

In some aspects of the present disclosure, the system includes a processing circuitry and a non-transitory computer-readable storage medium storing instructions executable by the processing circuitry to cause the system to incentivize decentralized app (DApp) owners and validators in a blockchain network. The method to facilitate incentivization includes determining an eligibility criterion for incentive distribution to a set of client nodes based on a count of minted nodes added to a network by the set of client nodes. The method to facilitate incentivization further includes obtaining a set of eligible client nodes from the set of client nodes based on the determined eligibility criterion.

Furthermore, the method to facilitate incentivization includes computing an incentive amount for each eligible client node of the set of client nodes respectively, computing an incentive amount for each validator node of a set of validator nodes respectively. Furthermore, the method to facilitate incentivization includes transferring the computed incentive amounts specific to each eligible client node and every validator node, to each eligible client node and every validator node respectively.

In some aspects of the present disclosure, prior to determining the eligibility criterion for incentive distribution to a set of client nodes, the method to facilitate incentivization includes obtaining the count of minted nodes added to the network by each client node of a set of client nodes respectively. Further, the method to facilitate incentivization includes validating the count of minted nodes added to the network by each client node of a set of client nodes respectively, by way of a set of validator nodes.

In some aspects of the present disclosure, prior to obtaining the count of minted nodes added to the network, the method to facilitate incentivization includes selecting an epoch to facilitating incentivization. In some aspects, prior to selecting an epoch to facilitating incentivization, the method to facilitate incentivization includes generating a set of smart contracts corresponding to each node associated with the network respectively.

In some aspects of the present disclosure, prior to computing the incentive amount for the eligible client nodes and the validator nodes, the method to facilitate incentivization includes obtaining a predefined stake amount in the form of native tokens from each validator node. Further, the method to facilitate incentivization includes deciding a share of the total stake amount to be distributed to the set of eligible client nodes, and obtaining the share of the total stake amount to be distributed to the set of validator nodes.

In some aspects of the present disclosure, prior to transferring the computed incentive amounts to each eligible client node and every validator node respectively, the method to facilitate incentivization includes convening native tokens into equivalent currency amount to be transferred.

In some aspects of the present disclosure, to compute the incentive amount in each epoch for each eligible client node, the method to facilitate incentivization includes computing a ratio of count of minted nodes added to the network by each eligible client node to the total count of minted nodes added in the network in each epoch, respectively, specific for each eligible client node. Further, to compute the incentive amount in each epoch for the eligible client nodes, the method to facilitate incentivization includes dividing share of the total incentive to be distributed to the set of eligible client nodes, in the computed ratio corresponding to each eligible client node, respectively.

In some aspects of the present disclosure, to compute the incentive amount in each epoch for each eligible client node, the method to facilitate incentivization includes computing the ratio of count of minted nodes added to the network by each eligible client node to the total count of minted nodes added in the network in each epoch, respectively, specific for each eligible client node. To compute the incentive amount in each epoch for the set of eligible client nodes, the method to facilitate incentivization further includes dividing the share of the total incentive to be distributed to the set of client nodes, by mapping the ratio to a look up table.

In some aspects of the present disclosure, to compute the incentive amount in each epoch for each eligible client nodes, the method to facilitate incentivization includes obtaining a ratio of an activity duration associated with each eligible client node of the set of eligible client nodes respectively and dividing the share of the total incentive to be distributed to the set of eligible client nodes, in the ratio of the activity duration associated with each eligible client node.

In some aspects of the present disclosure, to compute the incentive amount for each validator node, the method to facilitate incentivization includes computing a ratio of count of validated minted nodes by each validator node to the total count of validator node in each epoch respectively, specific to each validator node. To compute the incentive amount for the validator nodes, the method to facilitate incentivization further includes dividing share of the total incentive to be distributed to the set of validator nodes, in the computed ratio corresponding to each validator node, respectively.

In some aspects of the present disclosure, to compute the incentive amount for each validator nodes, the method to facilitate incentivization includes computing a ratio of count of validated minted nodes by each validator node to the total count of validator node in each epoch respectively, specific to each validator node. To compute the incentive amount for the validator nodes, the method to facilitate incentivization further includes dividing the share of the total incentive to be distributed to the set of validator nodes, by mapping the ratio to a look up table. In some aspects of the present disclosure, to compute the incentive amount for each validator nodes, the method to facilitate incentivization includes obtaining a ratio of an activity duration associated with each validator node of the set of eligible client nodes respectively. To compute the incentive amount for the validator nodes, the method to facilitate incentivization further includes dividing the share of the total incentive to be distributed to the set of validator nodes, in the ratio of the activity duration associated with each validator node.

### BRIEF DESCRIPTION OF THE DRAWINGS

The drawing/s mentioned herein disclose exemplary aspects of the present disclosure. Other objects, features, and advantages of the aspect will be apparent from the following description when read with reference to the accompanying drawings. In the drawings, wherein like reference numerals denote corresponding parts throughout the several views:

The diagrams are for illustration only, which thus is not a limitation of the present disclosure, and wherein:

FIG. 1 illustrates a block diagram of a system for incentivization, according to an exemplary aspect of the present disclosure;

FIG. 2 illustrates a block diagram of a server of the system of FIG. 1, according to an aspect of the present disclosure;

FIG. 3 illustrates another block diagram of the system for incentivization, according to an exemplary aspect of the present disclosure;

FIG. 4 illustrates yet another block diagram of the system for incentivization, according to an exemplary aspect of the present disclosure;

FIG. 5 illustrates a method for incentivization of a client node, according to an exemplary aspect of the present disclosure; and

FIG. 6 illustrates a method for incentivization of a client node, according to an exemplary aspect of the present disclosure.

To facilitate understanding, like reference numerals have been used, where possible to designate like elements common to the figures.

### DETAILED DESCRIPTION OF THE PREFERRED ASPECTS

The aspects herein and the various features and advantageous details thereof are explained more fully with reference to the non-limiting aspects that are illustrated in the accompanying drawings and detailed in the following description. Descriptions of well-known components and processing techniques are omitted so as to not unnecessarily obscure the aspects herein. The examples used herein are intended merely to facilitate an understanding of ways in which the aspects herein may be practised and to further enable those of skill in the art to practice the aspects herein. Accordingly, the examples should not be construed as limiting the scope of the aspects herein.

The system (100) may facilitate the development of a network having economical models to support and incentivize Decentralised Application (DApp) owners contributing to transaction volumes on the network. Specifically, the system (100) may facilitate to bring inclusion of DAPP owners and incentivize the DApp owners by sharing some or any percentage of validator rewards with DApp owners so that as the DApp owners grow projects on to a public blockchain network, the DApp owners also feel appreciated for bringing the traffic to the public blockchain network. Further, the system (100) may facilitate rewarding incentives to the DApp owners based on thresholding on respective smart contracts cross a predetermined threshold in native tokens of the network.

In some aspects, the system (100) may be configured to distribute the reward incentives at fixed intervals (i.e referred to as an epoch) and facilitate in ensuring that the validator rewards are not ignored. Specifically, the epoch may represent a period of time during which there is a specific set of active validators. Each epoch may include n blocks such that before the last block the active set of the next epoch is elected and after the end of each epoch, the rewards are calculated and are ready to be distributed to the validators and nominators. In some aspects of the present disclosure, the duration of each epoch is configurable and can be a period of 1 month.

In some aspects, the system (100) may provide a fast and efficient database, a modular peer-to-peer (P2P) networking stack, a configurable transaction queue, a flexible runtime library, and a light client optimised. Specifically, the system 100 may initiate the blockchain with a pre-minted supply of a predefined number of native coins. The system (100) may be configured to provide validator reward to validator nodes on successful addition of a new block to the chain. Every n block constitutes an epoch. The DApp owner incentives in the network are distributed at the end of every epoch. The incentive will be distributed to the smart contract addresses of DApps which are eligible for rewards. The system (100) may enable the DApp owners to ensure they have a fallback function to withdraw funds out of the smart contract or else it will be locked in the smart contract forever.

The system (100) may include a network of a plurality of nodes, wherein the network is configured to possess properties of blockchain technology through the nodes. The users may be a decentralized app (DApp) owner (hereinafter interchangeably referred to as a “client node” in perspective of the network) or a validator (hereinafter interchangeably referred to as “validator node”). Further, with addition of new nodes (referred to as “minted nodes”) to the network (addition of minted nodes to the network hereinafter is interchangeably referred to as “transaction”), the client nodes adding the minted nodes and the validator nodes validating the minted nodes may be rewarded with incentives. Furthermore, each node in the network may be configured to perform functionality based on respective smart contracts. The network may further include one or more developers (hereinafter interchangeably referred to as “full nodes”) configured to perform one or more operations of the system to facilitate incentivization.

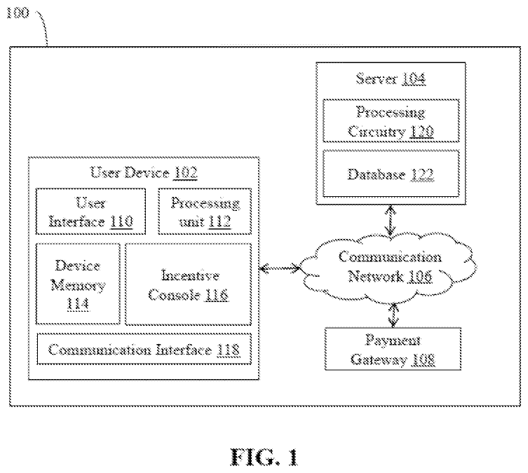

Referring initially to the drawings, FIG. 1 is a block diagram that illustrates a system (100) for incentivization associated with a user, in accordance with an exemplary aspect of the present disclosure. In some aspects of the present disclosure, the system may include a user device (102), a server (104) and a payment gateway (108), communicatively coupled to each other via a communication network (106). In other aspect of the present disclosure, the user device (102), the server (104) and the payment gateway (108) may be communicably coupled through separate communication networks established therebetween.

The user device (102) may be configured of facilitate a user to input data, receive data, and/or transmit data within the system (100). In some aspects of the present disclosure, referring to FIG. 1, the user device (102) may include a user interface (110), a processing unit (112), a device memory (114), an incentive console (116) and a communication interface (118).

In some aspects, the user interface (110) may include an input interface for receiving inputs from one or more first users and/or one or more second users. The input interface may be configured to fetch inputs and/or personal details of a plurality of the users (One or more first users and/or one or more second user hereinafter may be referred to as “users”).

In some aspects, the processing unit (112) may include suitable logic, instructions, circuitry, interfaces, and/or codes for executing various operations associated with the user device (102). In some aspects, the processing unit (112) may be configured to control one or more operations executed by the user device (102) in response to the input received at the user interface (110) from the user.

In some aspects, the device memory (114) may be configured to store the logic, instructions, circuitry, interfaces, and/or codes of the processing unit (112), data associated with the user device (102), and/or data associated with the system (100).

In some aspects, the incentive console (116) may be configured as one or more computer-executable application, to be executed by the processing unit (114) and may include suitable logic, instructions, and/or codes for executing various operations and may be controlled by the server (104). The one or more computer executable applications may be stored in the device memory (114).

In some aspects, the payment gateway (108) may be configured to facilitate one or more second users to buy tokens for stakes. The payment gateway (108) may further be configured to facilitate one or more first user and/or one or more second user to receive respective incentives.

In some aspects, the communication interface (118) may be configured to enable the user device (102) to communicate with the server (104) and the payment gateway (108) through the communication network (106). It will be apparent to a person of ordinary skill in the art that the communication interface (118) may include any device and/or apparatus capable of providing wireless or wired communications between the user device (102), the server (104) and the payment gateway (108) over the communication network (106).

The server (104) may be a network of computers, a software framework, or a combination thereof, that may provide a generalized approach to create the server implementation. The server (104) may be maintained by a storage facility management authority or a third-party entity that facilitates service enablement and resource allocation operations of the system (100). The server (104) may include a processing circuitry (120) and one or more data repositories (hereinafter, collectively referred to and designated as “Database”) (122).

In some aspects, the processing circuitry (120) may include suitable logic, instructions, circuitry, interfaces, and/or codes for executing various operations. The processing circuitry (120) may be configured to host and enable the incentive console (116) running on (or installed on) the user device (102) to execute the operations associated with the system (100) by communicating one or more commands and/or instructions over the communication network (106).

In some aspects, the database (122) may be configured to store the logic, instructions, circuitry, interfaces, and/or codes of the processing circuitry (120) for executing a plurality of operations. The database (122) may be further configured to store therein, data associated with users registered with the system (100). Some aspects of the present disclosure are intended to include and/or otherwise cover any type of the data associated with the users registered with the system (100).

In some aspects, the communication network (106) may include suitable logic, circuitry, and interfaces that may be configured to provide a plurality of network ports and a plurality of communication channels for transmission and reception of data related to operations of various entities such as the user device (102), the server (104) and the payment gateway (108) of the system (100). Each network port may correspond to a virtual address (or a physical machine address) for transmission and reception of the communication data. The communication network (106) may be associated with an application layer for implementation of communication protocols based on one or more communication requests from the user device (102) the server (104) and the payment gateway (108). The communication data may be transmitted or received, via the communication protocols.

In some aspects of the present disclosure, the communication data may be transmitted or received via at least one communication channel of a plurality of communication channels in the communication network (106). The communication channels may include, but are not limited to, a wireless channel, a wired channel, a combination of wireless and wired channel thereof. Aspects of the present disclosure are intended to include or otherwise cover any type of communication channel, including known, related art, and/or later developed technologies.

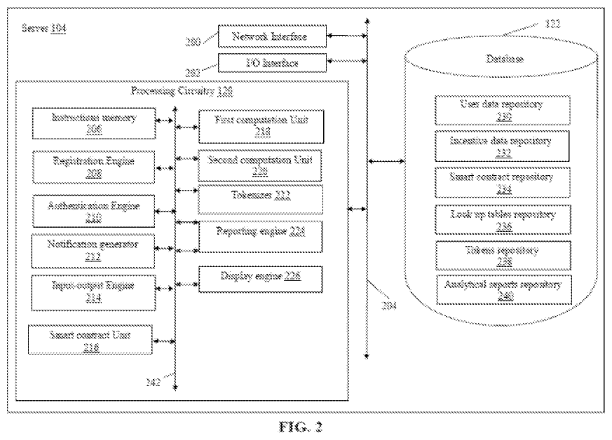

FIG. 2 is a block diagram that illustrates the server (104) of FIG. 1, in accordance with an aspect of the present disclosure. The server (104) may include the processing circuitry (120) and the database (122). The server (104) may further include a network interface (200) and an input/output (I/O) interface (202). In an aspect, the processing circuitry (120), the database (122), the network interface (200), and the input/output (I/O) interface (202) may be configured to communicate with each other by way of a first communication bus (204).

In some aspects of the present disclosure, the processing circuitry may include a plurality of components such as an instruction memory (206), a registration engine (208), an authentication engine (210), a notification generator (212), an input-output engine (214), a smart contract unit (216), a first computation unit (218), a second computation unit (220), a tokenizer (222), a reporting engine (224) and a display engine (226). The plurality of components of the processing circuitry (120) may be coupled to each other by way of a second communication bus (242). It will be apparent to a person having ordinary skill in the an that the server (104) is for illustrative purposes and not limited to any specific combination of hardware circuitry and/or software.

In some aspects of the present disclosure, the database (122) may include a user data repository (230), an incentive data repository (232), a smart contract repository (234), a look up table repository (236), a token repository (238) and an analytical reports repository (240).

In some aspects of the present disclosure, the registration engine (208) may be configured to enable the users to register into the system (100) by providing registration data through a registration menu (not shown) of the translation console (116) displayed through the user device (102).

In some aspects of the present disclosure, the database (122) may include a user data repository (230), an incentive data repository (232), a smart contract repository (234), a look up table repository (236), a token repository (238) and an analytical reports repository (240).

In some aspects, the user data repository (230) may be configured to store the personal data associated with the users. The incentive data repository may be configured to store the data of incentives facilitated to the users by the system (100). The smart contract repository may include the smart contracts of each user in the network. Further, the smart contract repository may include smart contracts for a plurality of operations of the system (100). The look up table repository (238) may include a plurality of look up tables configured for operations such as incentive calculation for a user, eligibility list of the users or the like. The token repository (238) may be configured to include a plurality of tokens associated with one or more processes of the system (100). The tokens may be used for but not limited to notification, transactions and or incentive distribution to the users of the system (100). The analytical reports repository may store analytical reports, history of activities and/or transactions associated with the users of the system (100).

In some respects, the registration data of the users may be stored in a user data repository (230) of the database (122). In another aspect, the device memory (114) may be configured to temporarily store the personal data obtained from the users by way of user interface (110).

In some aspects, the authentication engine (210) may be configured to fetch a personal data provided by the user from either the device memory (114) or the user data repository (230) and authenticate the user's profile based on the comparison and verification of information provided by the user. Upon successful authentication of the user, the notification generator (212) may be configured to generate a successful authentication notification that may be displayed through the registration menu as a pop-up notification. The notification generator (212) may further be configured to generate a failed authentication notification as a pop-up upon failed authentication by the authentication engine (210). The notification may be displayed through the output interface by way of the display engine (226). Furthermore, the notification generator (214) may be configured to generate notifications for one or more operations performed by the system (100).

In some aspects, the input-output engine (214) may be configured to fetch the personal data provided by the users through user interface (110) and store it in the user data repository (230). Further, the input-output engine (214) may be coupled to one or more components of the processing circuitry (120) by way of the second communication bus (242) and may be configured to fetch data from one or more components of the processing circuitry and store the data into corresponding repositories of the database (122). Furthermore, the input-output engine (214) may be configured to fetch data from one or more repositories of the database (122) and may be configured to provide the fetched data to one or more components of the processing circuitry (120) to perform one or more operations of the system (100).

In some aspects of the present disclosure, the smart contract unit (216) may be configured to generate, create, upload and/or deploy protocols in the form of smart contracts to each user in the network. Further, the smart contract unit (216) may be configured to create and/or deploy protocols for the overall functionality of the system (100) through one or more smart contracts assessing the other smart contracts of the system (100). The smart contracts may be developed by one or more developers in the network (also referred as “full nodes” in the network).

In some aspects of the present disclosure, the first computation unit (218) may be configured to add minted nodes to the network by one or more client nodes. Further, the first computation unit (216) may be configured to validate the added minted node to the network by one or more validator nodes. Furthermore, the first computation engine may be configured to compute the number of minted nodes added and number of validations done in each epoch. In some aspects, the first computation unit (218) may be configured to determine an eligibility criterion for the set of client nodes to receive incentives based on a count of transactions done by each client node. Further, the first computation unit (218) may be configured to determine eligible client nodes from the set of client nodes, eligible to receive incentives associated with each client nodes of the set of client nodes. Furthermore, the first computation engine (218) may be configured to obtain the eligibility criteria through voting-based democracy in the network, wherein, one or more nodes of the network participate in the voting. In some aspects, the first computation engine (218) may be configured with proof of stake based distributed consensus mechanism and may receive an amount from each validator node through payment gateway (108).

In some aspects of the present disclosure, the first computation unit (218) may be configured to count the number of minted nodes added to the network in each epoch. The first computation unit (218) may further be configured to determine an eligibility criterion for selecting a client node for incentivization. Furthermore, the first computation unit (218) may be configured to select the duration of each epoch. Furthermore, the first computation unit (218) may be configured to obtain the set of eligible client nodes on the network for incentivization in each epoch.

In some aspects, the first computation unit (218) may be configured to count the number of validations done by each validator node of the network in each epoch. Further first computation unit (218) may be configured to obtain the status of a pre-defined set of validators on the network prior to incentivization.

In some aspects of the present disclosure, the second computation unit (220) may be configured to verify each transaction by every client node of the set of client nodes and determine an incentive amount for each eligible client node of the set of client nodes and each validator node of the set of validator nodes respectively. Further, the second computation unit (220) may be configured to transfer by way of the payment gateway (108), the determined incentive amount specific to each eligible client node of the set of client nodes and each validator node of the set of validator nodes respectively.

In some aspects of the present disclosure, the second computation unit (220) may be configured to obtain a stake amount from each validator present on the network. Further, second computation unit (220) may be configured to decide the ratio of the total distribution of incentives to the client nodes and the validator nodes. Furthermore, the second computation unit (220) may be configured to select an incentive distribution method for the system (100). Furthermore, second computation unit (220) may be configured to compute incentive amount for the eligible client nodes and the validator nodes on the network and transfer the respective amounts to eligible each node.

In some aspects of the present disclosure, the tokenizer (222) may be configured to generate tokens corresponding to the stake amount received by the validator nodes. Further, the tokenizer (222) may be configured to generate tokens for distribution of incentives to each eligible client node and every validator node. Furthermore, the tokenizer (222) may be configured to generate tokens for one or more notifications and/or transactions in the system (100).

In some aspects, the reporting engine (224) may be configured to perform analysis on one or more transactions of the system and may create analytical reports based on the analysis. The display engine (226) may be configured to display the analytical reports, personal user data, notifications, incentives data or the like to the user by way of the user interface (110).

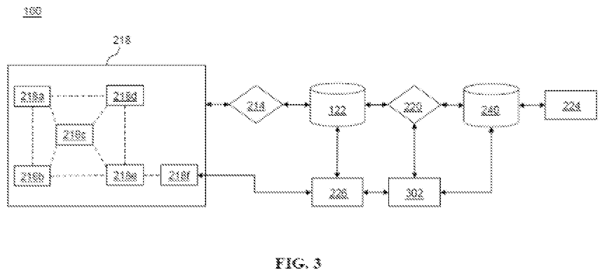

FIG. 3 illustrates a block diagram of a system (100), according to an aspect of the present disclosure. The system (100) may include the first computation unit (218), the input-output engine (214), the database (122), the second computation unit (220), the reporting engine (224), and the display engine (226).

The first computation unit (218) for each client in the network may include a plurality of full nodes of which first and second full nodes (218a) and (218b) are shown, a plurality of validator nodes of which first through third validator nodes (218c-218e) are shown, and a client node (218f). The first and second full nodes (218a) and (218b), the first through third validator nodes (218c)-(218e) and the client node (218f) may be coupled to one another to form the network. The first computation unit (218) may be configured to execute a fully functional proof of stake (POS) blockchain with the support of smart contracts.

In some aspects of the present disclosure, a smart contract may be deployed on the network to keep track of the client nodes that have been eligible to get reward incentives according to predefined criteria. Specifically, the predefined criteria may be defined based on voting with the help of democracy and governance protocol.

In some aspects of the present disclosure, the first computation unit (218) may be configured to utilise a proof-of-stake consensus mechanism to achieve distributed consensus that may require users to stake the native coin to become a validator in the network. Validator nodes are responsible for the same thing as miners in proof-of-work i.e., ordering transactions, validating minted nodes and creating new nodes/block in the network so that all nodes can agree on the state of the network. Specifically, the proof-of-stake consensus mechanism provides better energy efficiency as a user don't need to use lots of energy mining blocks, lower barriers to entry, reduced hardware requirements as the user don't need elite hardware to stand a chance of creating new blocks, stronger immunity to centralization as proof-of-stake should lead to more nodes in the network, and stronger support for shard chains that may act as a key upgrade in scaling. Further, the first computation unit (218) may be configured to measure how much “stake” any particular account has. The unit of measurement may be “tokens” that may be a scalar value associated with an account. In some aspects of the present disclosure, the validators may be elected, infrequently (at most once per day but perhaps as seldom as once per quarter).

The input-output engine (214) may include suitable logic and circuitry that can be configured to perform one or more operations. For example, the input-output engine (214) may be configured to receive and/or fetch data from the first computation unit (218) and to further push the data into the database (122) to generate reports and providing historical data for analytical purposes. In some aspects of the present disclosure, the input-output engine (214) may be configured to push each transaction and/or account data into the database (122).

The database (122) may be configured for storage and retrieval of data associated with the system (100). Specifically, the database (122) may be configured to store each transaction and/or account data received and/or fetched from the network for reporting purposes. Examples of the database (122) may include but are not limited to, a centralised database, a distributed database, a relational database, a NoSQL database, a cloud database, an object-oriented database, a hierarchical database, a network database, and the like. In a preferred aspect of the present disclosure, the database (122) may be a MySQL database. Aspects of the present disclosure are intended to include or otherwise cover any type of the database (122) known to a person of ordinary skill in the art.

The second computation unit (220) may be coupled to the database (122). The second computation unit (220) may include suitable logic and circuitry that can be configured to perform one or more operations. For example, the second computation unit (220) may be configured to execute an artificial intelligence technique to verify each transaction in the database (122) to generate an eligible list of smart contracts that qualify for the reward incentives. The second computation unit (220) may further store the eligible list of smart contracts in a look up table (LUT) in the lookup table repository (236) of the database (122) and further push the transactions to the smart contract repository (234) to keep a record.

In another aspect of the present disclosure, the system (100) may include an analytical report repository (240), that may be coupled to the second computation unit (220) such that the second computation unit (220) stores the eligible list of smart contracts in the analytical report repository (240) and further pushes the transactions to a smart contract to keep a record in the system (100).

In some aspects of the present disclosure, the second computation unit (220) may be further configured to send a reward incentive to a deployed address of each qualified smart contract based on the predefined criteria. As discussed above, the predefined criteria may be defined by democracy in the network by creating a proposal and by voting. The second computation unit (220) may be further configured to distribute each reward incentive immediately. The second computation unit (220) may be further configured to provide details (302) of each transaction to the display engine (226).

In some aspects, the reporting engine (224) may be coupled to the analytical report repository (240). The reporting engine (224) may include suitable logic and circuitry that can be configured to perform one or more operations. For example, the reporting engine (240) may be configured to create charts and other visual analysis reports based on the stored data associated with the system (100).

The display engine (226) may be coupled to the database (122). The display engine (226) may include suitable logic and circuitry that can be configured to perform one or more operations. For example, the display engine (226) may be configured to display all records from the network through a user interface (102). The display engine (226) may be configured to communicate with the client node 102f to display all records from the network.

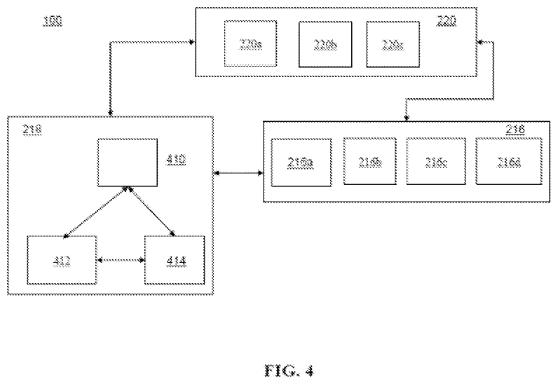

FIG. 4 illustrates another block diagram of the system (100), according to an aspect of the present disclosure. In some aspects of the present disclosure, the system (100) by way of the smart contract unit (216) may enable the users and/or the developers to create and upload smart contracts. The smart contract unit (216) includes a first sub-block (216a), a second sub-block (216b), a third sub-block (216c) and a Software Development Kit (SDK) (216d). The first sub-block (216a) enables the user and/or the developer to create the smart contracts by utilizing a smart contract Software Development Kit (SDK)(216d). The second sub-block (216b) enables the user and/or the developer to deploy the smart contract to a network (e.g., an ABC network). The third sub-block (216c) may be configured to notify the deployment of the minted node to the network.

In some aspects, the system (100) may further include components of the first computation engine (218), such as an update block (410), a logger (412), and a democracy block (414) and components of second computation engine (220), such as a reward block (220a), transaction verification engine (220b) and transfer engine (220c). The reward block (220a) may be configured to mine and/or add minted blocks to the network and further set incentives to be distributed based on the transactions. In some aspects of the present disclosure, the reward block (220a) may be configured to determine pay-out of the incentives based on a method selected from one of, an incentive pay-out on Pro-Rata basis at the end of every epoch method, an incentive pay-out on fixed slabs of achievements method, a caveat incentive pay-out on number of active hours method.

In some aspects of the present disclosure, a total validator incentive to client incentive will follow an X:Y ratio. Specifically, when a fixed block incentive for every minted block is ABC, the

$$validator incentive = \frac{X}{X + Y} * ABC + \sum$$

transaction fees for the block. Further, the client node incentive at the end of every epoch (for n blocks) may be computed as

$$\frac{Y}{X + Y} * ABC * n .$$

The incentive calculation for each eligible client node as well as every validator node may follow either one of three pay-outs based on pro-rata basis or fixed slab basis or activity time basis.

In some aspects of the present disclosure, the incentive pay-out on Pro-Rata basis at the end of every epoch method may be used that is an incentive pay-out structure at the end of an epoch based on the number of new transactions done to or from a user (hereinafter interchangeably referred to as “smart contract address”) for the period of each epoch. The method may be customizable and can also provide the option of staking by the validator nodes. In an exemplary scenario, the network includes 3 smart contracts A, B & C and the incentive pool amounts to I. Further, the number of transactions that were committed to or from smart contracts A, B, and C are 100, 200, and 200, respectively. In such scenario, the system (100) at the reward block (220a) may determine the ratio for incentivization of A, B, and C on Pro-Rata basis that becomes 20%, 40%, and 40%, respectively such that incentivization for A=20%×I, incentivization for B=40%×I, and incentivization for C=40%×I. Specifically, incentivization for A maybe 20% (20 incentive tokens) as the number of transactions that were committed are only 100. Further, incentivization for B maybe 40% (40 incentive tokens) as the number of transactions that were committed are 200 that is twice the number of transactions. Furthermore, incentivization for C maybe 40%(40 incentive tokens) as the number of transactions that were committed are 200 that is twice the number of transactions.

In some aspects of the present disclosure, the incentive pay-out on fixed slabs of achievements method can be used. The incentive pay-out structure at the end of an epoch is based on the number of new transactions done to or from a smart contract address for an entire period. The system (100) at reward block (220a) may define multiple slabs that when achieved, the smart contract would be rewarded with a percentage of the incentivization pool based on the slab it qualifies for. Further, the reward may be part of the coin incentivization mechanism either from the validation reward pool or separately allocated within the token economics of said blockchain. In some aspects of the present disclosure, the incentive may be given either in native currency or in a separate currency with different utility altogether. For example, the slab ranges maybe, but not limited to, transaction volume below >100,00—0%, transaction volume equal to =100,000—10%, transaction volume between 100,000-200,000—20%, transaction volume between 200,000-500,000—30%, transactions equal to and above >=500,000—40%, and the like. Aspects of the present disclosure are intended to include and/or otherwise cover any type of slab ranges as per the requirements.

In the exemplary scenario, the network includes 5 smart contracts A, B, C, D, and E and the incentive pool amount is 1. The number of transactions that were committed to or from smart contracts may be determined by the reward block (220a) of the system (100). For example, the number of transactions that were committed to or from smart contracts are A 50K. B=100K, C=150K, D=250K, and E=600K. Based on the above data the system (100) may determine incentivization by an incentivization formula that may be a weighted average of their slab percentages. Specifically,

$$Incentivization ( {N}_{i} ) = \frac{1 * Slab Percentage of Node if met}{\sum Slab Percentage of all Nodes} .$$

Such that, incentivization for A=0 (no slab met),

$$Incentivization for B = \frac{1 * 20}{110} ,$$

$$Incentivization for C = \frac{1 * 20}{110} ,$$

$$Incentivization for D = \frac{1 * 30}{110} , and$$

$$Incentivization for E = \frac{1 * 40}{110} .$$

Specifically, incentivization of A will be 0 as it has not met even the minimum required slab. The incentivization of B will be 10 tokens as it has met the minimum requirement of slab 100 k transactions which rewards him with 10%. The incentivization of C will be 20 tokens as it fits in the second slab of 100 k-200 k transactions which rewards him with 20%. The incentivization of D will be 30 tokens as it fits the third slab of 200 k-500 k transactions which rewards him with 30%. The incentivization of E will be 40 tokens as it fits the third slab of 500 k transactions which rewards him with 40%.

In some aspects of the present disclosure, the caveat incentive pay-out on the number of active hours method can be used. The system (100) may enable the network to ensure that node always has an incentive at being active. This means that there needs to be a period (could be counted in epochs) for which when a smart contract is awarded rewards for qualifying a particular slab. In an exemplary scenario, when an inactivity allowance period is of T epochs. The incentivization pallet can keep a datastore of how long the node has been active. For example, A=Active for 1000 hours, B=Active for 2000 hours, C=Active for 3500 hours. In some aspects of the present disclosure, the system (100) may be configured to determine the reward based on the conditions such as 1000-2000 hours=10%, 2000-3000 hours=15%, >3000=20%. Specifically, when the node is Active for 1000 hours reward will be 10% thus reward for A will be 100 Tokens. When the node is active for 2000 hours reward will be 15% thus reward for B will be 300 Tokens. When the node is active for 3500 hours reward will be 20%, thus reward for C will be 700 tokens.

In some aspects, the system (100) by way of the reward block (220a) may be further be capable of determining penalties. In one aspect, when the A=1000 Inactive Hours, B=2000 Inactive Hours, and C=3500 Inactive Hours. The system (100) may determine the penalties for staying inactive that may be according to the conditions such as 1000-2000=15% number of inactive hours, 2000-3000=17.5% number of inactive hours, >3000-25% Number of inactive hours, and the like. Specifically, when inactive for 1000 hours penalty will be 10%, the penalty for A will be 150 tokens (i.e., A will be 15%=150 Token Penalty), when inactive for 2000 hours penalty will be 17.5%, the penalty for B will be 350 Tokens (i.e., B will be 20%=350 Token penalty), and when inactive for 3500 hours reward will be 25%, the penalty for C will be 750 Tokens (i.e., C will be 25%=750 Token penalty).

In some aspects of the present disclosure, the logger (412) may be coupled to the update block (410) and the democracy block (414). The logger (412) may include suitable logic and circuitry to perform one or more operations. For example, the logger (412) may be configured to categorise each smart contract by putting each smart contract in defined categories. Further, the logger (412) may be configured to store all volume information of each smart contract. The logger (412) in combination with the reward block (408) and the update block (410) may be configured to distribute the rewards.

In some aspects of the present disclosure, the update block (410) may be configured to update the smart contract based on the selected pay-out scheme selected. The democracy block (414) of the system (100) may enable members in staking to vote on proposed proposals. Further, the democracy block (414) may provide the voting data to the update block (410) such that the update block (410) updates the voting data on the network.

In some aspects, the transaction verification engine (220b) may be configured to verify each transaction in the network. Further, the transfer engine (220c) may be configured to transfer or make payment to the nodes in accordance with the calculated incentives.

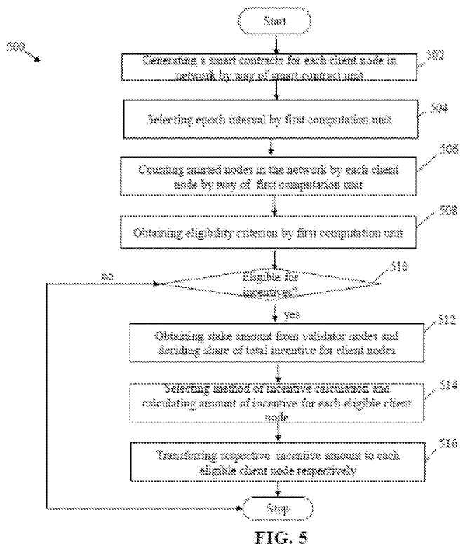

FIG. 5 illustrates a method for incentivization of a client node, according to an exemplary aspect of the present disclosure.

At step (502), the system (100), by way of the smart contract unit (216) may be configured to generate a of smart contracts for each client node in the network.

At step (504), the system (100), by way of the first computation unit (218), may be configured to select an epoch interval for incentivization.

At step (506), the system (100), by way of the first computation unit (218), may be configured to count the number of minted nodes added in each epoch by each client node to the network.

At step (508), the system (100), by way of the first computation unit (218), may be configured to obtain an eligibility criterion for incentivization of a client node on the network.

At step (510), the system (100), by way of the first computation unit (218), may be configured to determine the eligibility of a client node as per the obtained eligibility criterion.

At step (512), the system (100), by way of the second computation unit (218), may be configured to obtain a stake amount from each validator nodes.

Further, at step (512), the system (100) may be configured to decide share of total incentive for client nodes.

At step (514), the system (100), by way of the second computation unit (218), may be configured to select a method from one or more methods of incentive calculation and further calculate the amount of incentive for each eligible client node.

At step (516), the system (100), by way of the second computation unit (218), may be configured to transfer the respective incentive amounts to each eligible client node.

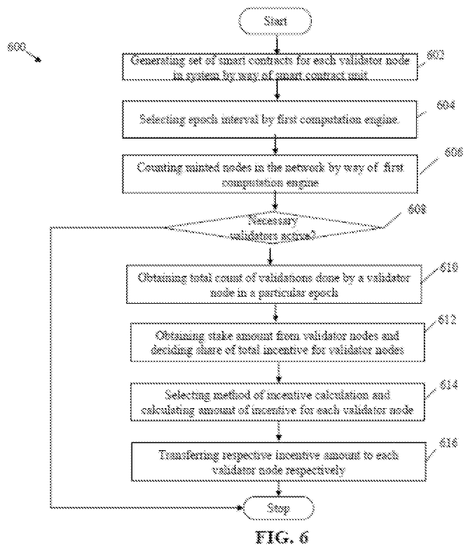

FIG. 6 illustrates a method for incentivization of a client node, according to an exemplary aspect of the present disclosure.

At step (602), the system (100), by way of the smart contract unit (216) may be configured to generate a of smart contracts for each validator node in the network.

At step (604), the system (100), by way of the first computation unit (218), may be configured to select an epoch interval for incentivization.

At step (606), the system (100), by way of the first computation unit (218), may be configured to count the number of minted nodes added in each epoch by each client node to the network.

At step (608), the system (100), by way of the first computation unit (218), may be configured to determine the presence of a pre-defined set of validator nodes on the network.

At step (610), the system (100), by way of the first computation unit (218), may be configured to obtain total count of validations done by each validator node in a particular epoch.

At step (612), the system (100), by way of the second computation unit (220), may be configured to obtain a stake amount from each validator nodes.

Further, at step (612), the system (100) may be configured to decide share of total incentive for the validator nodes.

At step (614), the system (100), by way of the second computation unit (220), may be configured to select a method from one or more methods of incentive calculation and further calculate the amount of incentive for each validator node.

At step (616), the system (100), by way of the second computation unit (220), may be configured to transfer the respective incentive amounts to each validator node.

Various aspects of the present disclosure provide the system (100) that allows the client nodes to be incentivized on the basis of the number of transactions that happen on its contract address. Further, the system (100) ensures constant motivation for client nodes to stay active for longer periods that further contributes to higher network utilisation. Furthermore, the system (100) ensures that the network remains secure and safe from fraudulent transactions and that the transactions are possible at affordable prices and within the least possible time. The system (100) further ensures that the blockchain is scalable without compromising security and that the highest amount of security is with cryptography. Furthermore, the system (100) ensures the distribution of tokens to the validators in a distributed and disciplined manner respecting the tokenization and the system (100) ensures that the transactions are not interrupted and breached. The system (100) is further capable of ensuring that validators as well as the smart contract owners are rewarded.

As will be readily apparent to those skilled in the art, aspects of the present disclosure may easily be produced in other specific forms without departing from their essential characteristics. Aspects of the present disclosure are, therefore, to be considered as merely illustrative and not restrictive, the scope being indicated by the claims rather than the foregoing description, and all changes which come within therefore intended to be embraced therein.

As one skilled in the art will appreciate, the system includes a number of functional blocks in the form of a number of units and/or engines. The functionality of each unit and/or engine goes beyond merely finding one or more computer algorithms to carry out one or more procedures and/or methods in the form of a predefined sequential manner, rather each engine explores adding up and/or obtaining one or more objectives contributing to an overall functionality of the system. Each unit and/or engine may not be limited to an algorithmic and/or coded form, rather may be implemented by way of one or more hardware elements operating together to achieve one or more objectives contributing to the overall functionality of the system. Further, as it will be readily apparent to those skilled in the art, all the steps, methods and/or procedures of the system are generic and procedural in nature and are not specific and sequential.

Certain terms are used throughout the following description and claims to refer to particular features or components. As one skilled in the art will appreciate, different persons may refer to the same feature or component by different names. This document does not intend to distinguish between components or features that differ in name but not structure or function. While various aspects of the present disclosure have been illustrated and described, it will be clear that the present disclosure is not limited to these aspects only. Numerous modifications, changes, variations, substitutions, and equivalents will be apparent to those skilled in the art, without departing from the spirit and scope of the present disclosure, as described in the claims.

We claim:

1. A system, comprising processing circuitry and a non-transitory computer-readable storage medium storing instructions that when executed by the processing circuitry, cause the system to:
determine an eligibility criterion for incentive distribution to a set of client nodes based on a count of minted nodes added to a network by the set of client nodes;
obtain a set of eligible client nodes from the set of client nodes based on the determined eligibility criterion;
compute an incentive amount for each eligible client node of the set of client nodes respectively;
compute an incentive amount for each validator node of a set of validator nodes respectively; and
transfer the computed incentive amounts specific to each eligible client node and every validator node, to each eligible client node and every validator node respectively.

2. The system of claim 1, wherein, prior to determining the eligibility criterion for incentive distribution to a set of client nodes, the system is configured to:
obtain the count of minted nodes added to the network by each client node of a set of client nodes respectively; and
validate the count of minted nodes added to the network by each client node of a set of client nodes respectively, by way of a set of validator nodes.

3. The system of claim 1, wherein, prior to obtaining the count of minted nodes added to the network, the system is configured to select an epoch to facilitating incentivization.

4. The system of claim 2, wherein, prior to selecting an epoch to facilitating incentivization the system is configured to generate a set of smart contracts corresponding to each node associated with the network respectively.

5. The system of claim 1, wherein prior to computing the incentive amount for the eligible client nodes and the validator nodes, the system is configured to:
obtain a predefined stake amount in the form of native tokens from each validator node;
decide a share of the total stake amount to be distributed to the set of eligible client nodes; and
obtain the share of the total stake amount to be distributed to the set of validator nodes.

6. The system of claim 1, wherein to compute the incentive amount in each epoch for each eligible client nodes, the system is configured to:
compute a ratio of count of minted nodes added to the network by each eligible client node to the total count of minted nodes added in the network in each epoch, respectively, specific for each eligible client node; and
divide share of the total incentive to be distributed to the set of eligible client nodes, in the computed ratio corresponding to each eligible client node, respectively.

7. The system of claim 1, wherein to compute the incentive amount in each epoch for each eligible client node, the system is configured to:
compute the ratio of count of minted nodes added to the network by each eligible client node to the total count of minted nodes added in the network in each epoch, respectively, specific for each eligible client node; and
divide the share of the total incentive to be distributed to the set of client nodes, by mapping the ratio to a look up table.

8. The system of claim 1, wherein to compute the incentive amount in each epoch for each eligible client node, the system is configured to:
obtain a ratio of an activity duration associated with each eligible client node of the set of eligible client nodes respectively; and
divide the share of the total incentive to be distributed to the set of eligible client nodes, in the ratio of the activity duration associated with each eligible client node.

9. The system of claim 1, wherein to compute the incentive amount for each validator nodes, the system is configured to:
compute a ratio of count of validated minted nodes by each validator node to the total count of validator node in each epoch respectively, specific to each validator node; and
divide share of the total incentive to be distributed to the set of validator nodes, in the computed ratio corresponding to each validator node, respectively.

10. The system of claim 1, wherein to compute the incentive amount in each epoch for each validator nodes, the system is configured to:
compute a ratio of count of validated minted nodes by each validator node to the total count of validator node in each epoch respectively, specific to each validator node; and
divide the share of the total incentive to be distributed to the set of validator nodes, by mapping the ratio to a look up table.

11. The system of claim 1, wherein to compute the incentive amount in each epoch for each validator nodes, the system is configured to:
obtain a ratio of an activity duration associated with each validator node of the set of eligible client nodes respectively; and
divide the share of the total incentive to be distributed to the set of validator nodes, in the ratio of the activity duration associated with each validator node.

12. The system of claim 1, wherein prior to transferring the computed incentive amounts to each eligible client node and every validator node respectively, the system is configured to convert one or more native tokens into equivalent currency amount to be transferred.

13. A computer implemented method for facilitating incentivization, the method comprising:
determining an eligibility criterion for incentive distribution to a set of client nodes based on a count of minted nodes added to a network by the set of client nodes;
obtaining a set of eligible client nodes from the set of client nodes based on the determined eligibility criterion;
computing an incentive amount for each eligible client node of the set of client nodes respectively;
computing an incentive amount for each validator node of a set of validator nodes respectively; and
transferring the computed incentive amounts specific to each eligible client node and every validator node, to each eligible client node and every validator node respectively.

14. The method for facilitating incentivization of claim 13, wherein the method further comprising:
generating a set of smart contracts corresponding to each node associated with the network respectively;
selecting an epoch to facilitating incentivization;
obtaining the count of minted nodes added to the network by each client node of a set of client nodes respectively;
validating the count of minted nodes added to the network by each client node of a set of client nodes respectively, by way of a set of validator nodes;
obtaining a predefined stake amount in the form of native tokens from each validator node;
deciding a share of the total stake amount to be distributed to the set of eligible client nodes;
obtaining the share of the total stake amount to be distributed to the set of validator nodes; and
converting native tokens into equivalent currency amount to be transferred.

15. The method for facilitating incentivization of claim 13, wherein to compute the incentive amount in each epoch for each eligible client node, the method comprising:
computing a ratio of count of minted nodes added to the network by each eligible client node to the total count of minted nodes added in the network in each epoch, respectively, specific for each eligible client node; and
dividing share of the total incentive to be distributed to the set of eligible client nodes, in the computed ratio corresponding to each eligible client node, respectively.

16. The method for facilitating incentivization of claim 13, wherein to compute the incentive amount in each epoch for each eligible client node, the method comprising:
computing the ratio of count of minted nodes added to the network by each eligible client node to the total count of minted nodes added in the network in each epoch, respectively, specific for each eligible client node; and
dividing the share of the total incentive to be distributed to the set of client nodes, by mapping the ratio to a look up table.

17. The method for facilitating incentivization of claim 13, wherein to compute the incentive amount in each epoch for each eligible client node, the method comprising:
obtaining a ratio of an activity duration associated with each eligible client node of the set of eligible client nodes respectively; and
dividing the share of the total incentive to be distributed to the set of eligible client nodes, in the ratio of the activity duration associated with each eligible client node.

18. The method for facilitating incentivization of claim 13, wherein to compute the incentive amount in each epoch for each validator node, the method comprising:
computing a ratio of count of validated minted nodes by each validator node to the total count of validator node in each epoch respectively, specific to each validator node; and
dividing share of the total incentive to be distributed to the set of validator nodes, in the computed ratio corresponding to each validator node, respectively.

19. The method for facilitating incentivization of claim 13, wherein to compute the incentive amount in each epoch for each validator node, the method comprising:
computing a ratio of count of validated minted nodes by each validator node to the total count of validator node in each epoch respectively, specific to each validator node; and
dividing the share of the total incentive to be distributed to the set of validator nodes, by mapping the ratio to a look up table.

20. The method for facilitating incentivization of claim 13, wherein to compute the incentive amount in each epoch for each validator node, the method comprising:
obtaining a ratio of an activity duration associated with each validator node of the set of eligible client nodes respectively; and
dividing the share of the total incentive to be distributed to the set of validator nodes, in the ratio of the activity duration associated with each validator node.
